(19) United States
(12) Patent Application Publication
(10) Pub. No.: US 2004/0173373 A1
(43) Pub. Date: Sep. 9, 2004

(54) Locking device for male/female electrical cable connectors

(76) Inventors: Stuart Hazard Wentworth, Alamo, CA (US); Claudia Hansen Wentworth, Alamo, CA (US)

Correspondence Address: CLAUDIA WENTWORTH, 108 CREST AVE, ALAMO, CA, 94507, US

(21) Appl. No.: 10/382,770

(22) Filed: Mar. 7, 2003

(51) Int. Cl. H02G 3/06

(52) U.S. Cl. 174/92

(57) ABSTRACT

A simple and inexpensive locking device used to secure the electrical connections between the male and female electrical connectors of a typical photovoltaic module. The cover secures high voltage connections from potential access by unqualified personnel. This locking device holds the electrical connection together over time ensuring that expansion and contraction will not negatively impact the electrical connection. The locking device is such that one half lock, when turned over and reversed, mates with the same identical shape, completing one unit. It is intended to be installed quickly and easily in both difficult and typical locations by hand, with hand pressure only. A standard electrical industry tool is needed to open the lock and access the underlying electrical cable, as required in high voltage applications. End barriers on the locking device secure the electrical cable from accidental or intentional separation by hand.

CROSS REFERENCE TO RELATED APPLICATIONS

| | | | |
|---|---|---|---|
| 4554401 | Nov., 1985 | Ball | 174/37. |
| 4605272 | Aug., 1986 | Myers et al. | |
| 5580266 | Dec., 1996 | Shelly. | |
| 5626486 | May, 1997 | Shelly et al. | |
| 4358178 | Nov., 1982 | | |

### BACKGROUND OF THE INVENTION

This invention is a device used to lock male/female cable connections and the serial connection of these cables. Made of a strong and durable material such as a weather and ultra violet light resistant plastic, the device covers and locks the male and female cable and a ‘y’ type harness wire assembly cable connectors and other multicontact cable connections. This locking device is able to be installed in the field without the use of tools but to access the underlying cable connection a basic tool within the electrical profession must be used.

Electrical cable connectors are known and used for electrical cable connections in various applications, particularly in the photovoltaic and solar energy field. The electrical cable connectors are an industry standard and are unable to be securely locked together for public safety. This locking device directly address' the need as set forth in the National Electric Code 2002.

The National Electric Code 2002, Article 690 Solar photovoltaic Systems, section 690.7 Maximum Voltage, subsection (D) Circuits Over 150 Volts to Ground. States “In one- and two-family dwellings, photovoltaic source circuits and photovoltaic output circuits over 150 volts to ground shall not be accessible to other than qualified persons while energized. FPN: see 110.27 for guarding of live parts, and 210.6 for voltage to ground and between conductors.”

Article 110 Requirements for Electrical Installations, section 110.27 Guarding of Live Parts. States: “(A) Live Parts Guarded Against Accidental Contact. Except as elsewhere required or permitted by this code, live parts of electrical equipment operating at 50 volts or more shall be guarded against accidental contact by approved enclosures or by any of the following means: (1) By location in a room, vault, or similar enclosure that is accessible only to qualified persons. (2) By suitable permanent, substantial partitions or screens arranged so that only qualified persons have access to the space within reach of the live parts. Any openings in such partitions or screens shall be sized and located so that persons are not likely to come into accidental contact with the live parts or to bring conducting objects into contact with them. (3) By location on a suitable . . . ”

“(B) Prevent Physical Damage. In locations where electric equipment is likely to be exposed to physical damage, enclosures or guards shall be so arranged and of such strength as to prevent such damage.”

“(C) Warning Signs. Entrances to rooms . . . ”

Currently, there is no device available on the market today to fulfill this requirement in current field applications utilizing the industry standard for photovoltaic connections.

The need has occurred only recently as the prior National Electric Code industry standard for photovoltaic panel connections were not to exceed 48 Volts. The multicontact and male/female electrical cable connector system for wiring photovoltaic panels has been a standard connection for this use. The Underwriters Laboratory has recently accepted and listed the components for a direct electrical grid tie system for use in both residential and commercial applications. The direct grid tie applications utilize high voltages of electrical distribution through these panels and their connections and feeds the electricity generated back out onto the electrical utility grid. These direct grid tie systems utilize panels connected by existing male/female electrical cable connectors in series of up to 600 Volts DC. This invention securely locks and holds together the male/female electrical cable connections under the National Electric Code 110-27.

We can find no prior art for such an invention.

### BRIEF SUMMARY OF THE INVENTION

The locking device for male/female electrical cable connectors is engineered for the ease of installation in both new and existing photovoltaic applications. This locking device does not need any special tools or devices for the installation. To be able to access the electrical cable below the locking device an industry hand tool and basic knowledge of the lock would be necessary for the removal of the lock. The locking device for male/female electrical cable connectors will both lock out easy entry to the electrical cable as well as help to keep the cables from pulling or pushing apart. The Ultra Violet and weather resistant hard plastic encapsulates the underlying cable connector helping to minimize the exposure to light and moisture when assembled.

Due to recent photovoltaic industry changes the use of high voltage cables has become standard practice in residential and commercial applications of photovoltaic solar systems. The basis of the invention for a locking device for male/female electrical cable connectors has become an immediate need for the photovoltaic industry to fulfill the electrical safety requirements as set forth in the 2002 National Electric Code.

### BRIEF DESCRIPTION OF THE SEVERAL VIEWS OF THE DRAWINGS

FIG. 1 is an exploded perspective view of the locking device, prior to insertion of the male/female photovoltaic electrical cable wire connection and assembly of the lock. The lower half is identical to the upper half. Both halves form a perfect union by simply rotation of the identical half. Upon mating the lower and upper halves around the male/female photovoltaic electrical cable wires, we complete one full locking device. All details are referenced by corresponding numbers.

FIG. 2 is a top plan view of the unassembled half lock lying on its round exterior.

FIG. 3 is an enlarged view of FIG. 2. section line 15 showing the internal ribband and external locking prong with prong ribs joined.

FIG. 4 is an enlarged cross-sectional view taken through FIG. 2 section line 16 between the locking component and the embrasure keyway, showing the edge tongue and edge groove feature for alignment

FIG. 5 is a plan view of the mid section embrasure keyway.

FIG. 6 is an enlarged cross-sectional view taken through FIG. 2 section line 17 of the embrasure keyway of an assembled unit.

FIG. 7 is an assembled perspective view.

Drawing Reference Numerals

1 Cable Hole

2 End Barrier

3 Internal Ridges

4 Locking Prongs

5 Embrasure Keyway

6 Alignment Holes

7 External Ridges

8 Edge Tongue

9 Edge Groove

10 One Half Lock

11 Inside Core Tapered

12 Inside Core Shaft

13 Prong Ribs

14 Ribbands

15 Section Line of Locking Prongs

16 Section Line of Edge Tongue and Edge Groove

17 Section Line of Embrassure Keyway

### DETAILED DESCRIPTION OF THE INVENTION

We wish it understood that we do not desire to be limited to the exact details of construction or method shown herein since obvious modifications will occur to those skilled in the relevant arts without departing from the spirit and scope of the following claims.

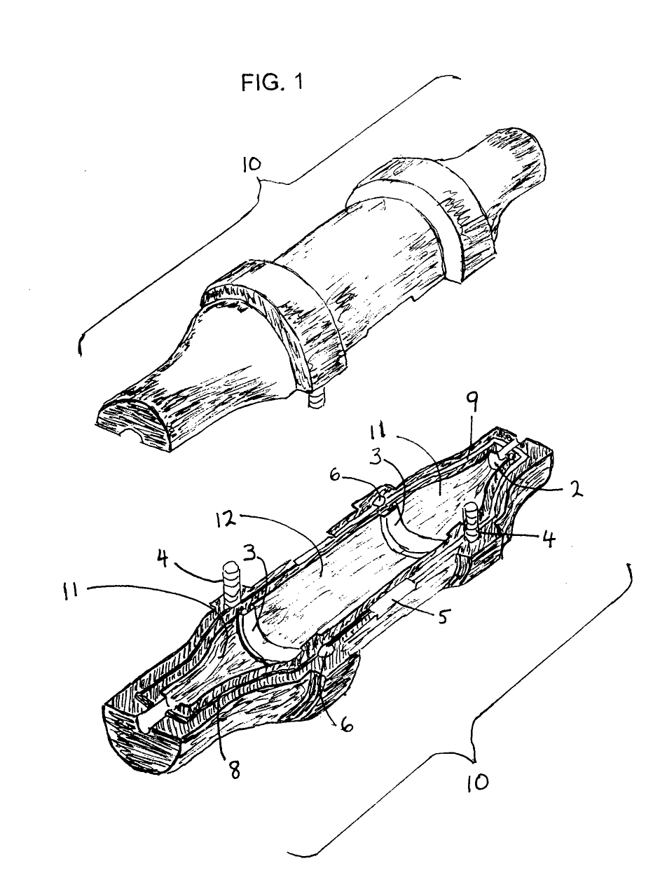

Referring to FIG. 1 the lock is designed symmetrically so that one half lock 10, when reversed and flipped over then squeezed together with mating one half lock 10, simply forms one complete locking device.

The inside core shown by 11, 3, and 12 are shaped to mate snugly with the exterior of one male/female photovoltaic or other electrical cable connection, not shown. When the male photovoltaic or other electrical cable is mated with the female photovoltaic or other electrical cable, the completed connection, not shown, is then encapsulated by the locking device as seen in FIG. 7.

The Internal ridges shown as 3 mate with the male/female photovoltaic or other electrical cable connection of the male and female components respectively. At each end, the conductor wire (not shown) would pass through cable hole 1, while end barrier 2 holds the male/female photovoltaic or other electrical cable connection from pushing apart due to current flow and or other expansion or contraction.

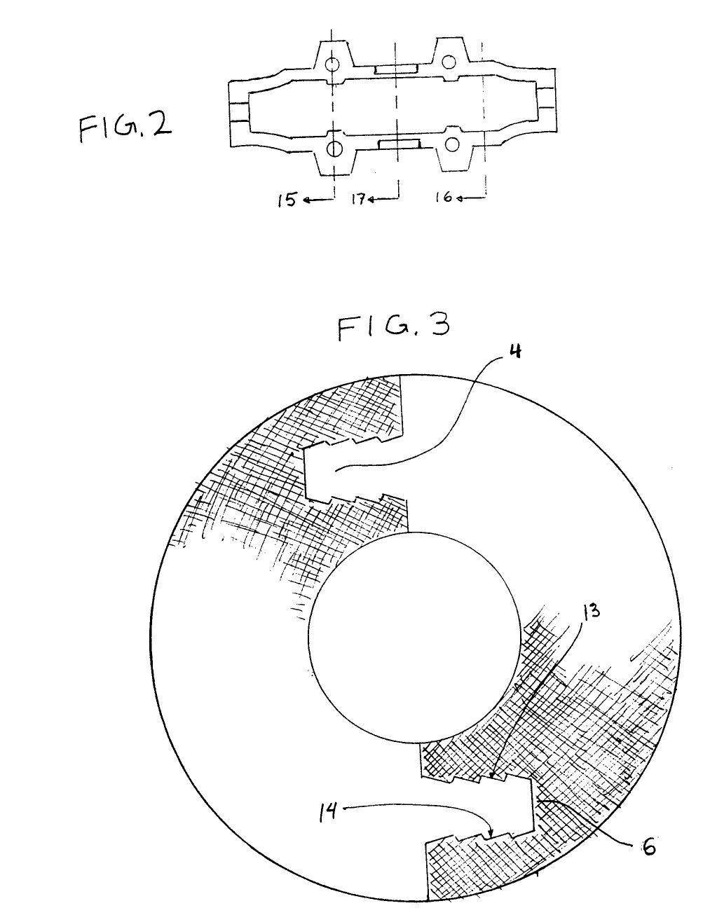

FIG. 3 is a view of the section line 15 of FIG. 2 showing the locking prongs 4 on one half lock 10, when reversed and flipped over, slip into alignment holes 6 on the other one half lock 10. Prong ribs 13 are beveled and mated to ribbands 14 using alignment holes 6, such that simple hand force applied to both one half lock 10 is sufficient to close the locking device.

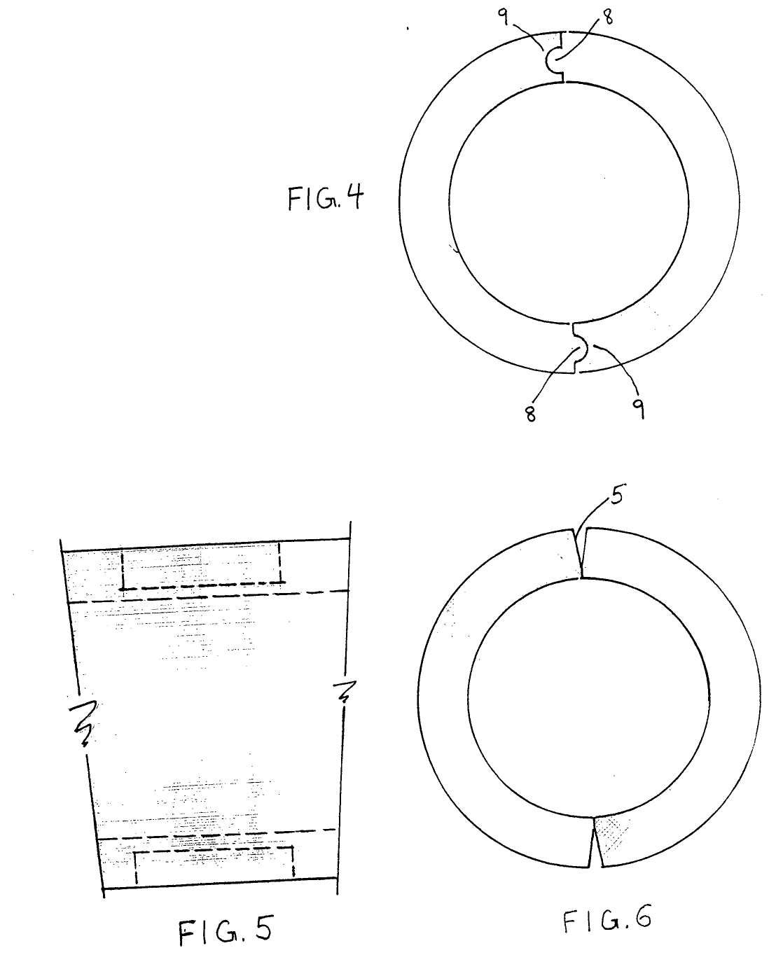

FIG. 4 is a view of section line 16 of FIG. 2 showing the final perimeter alignment that is provided by edge tongue 8 and edge groove 9 and when fully engaged. This engagement provides a smooth exterior seam as shown in FIG. 4. Edge tongue and groove will also help in minimizing the connector's exposure to light and moisture when it is assembled.

FIG. 5 is a plan view of the mid section embrasure keyway 5.

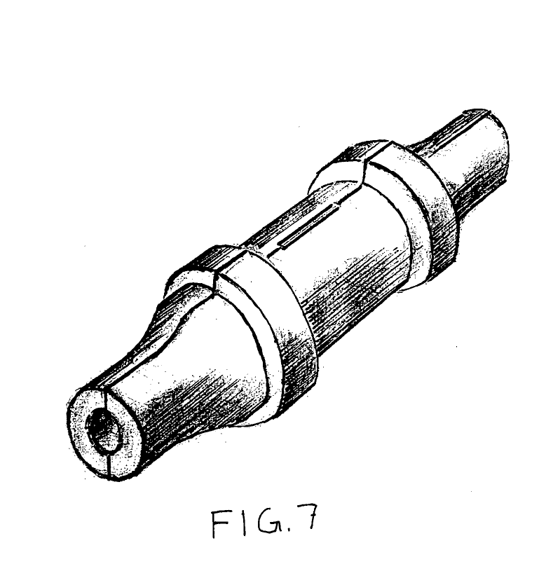

FIG. 6 is a view of section line 17 of FIG. 2 showing the embrasure key way 5 provides tool access for releasing of the locking device.

FIG. 7 is an assembled perspective view of two of 10.

We claim:

1. Ribbed prongs interlock so they are unable to be separated without the use of a standard industry hand tool.

2. Physical reversing of the invention allows one standard part to perform the function of both sides of the lock.

3. Keyway allows a tool edge to pry open the lock and access the underlying cable connection without damage to the connection.

4. End barriers are in place to keep the male and female electrical connectors interlocked within the locking device.

5. Minimal skill is needed to install protective cover.
